(19) United States
(12) Patent Application Publication
(10) Pub. No.: US 2025/0215541 A1
(43) Pub. Date: Jul. 3, 2025

(54) SOFT MAGNETIC IRON ALLOY SHEET, METHOD OF MANUFACTURING SOFT MAGNETIC IRON ALLOY SHEET, AND IRON CORE AND ROTATING ELECTRIC MACHINE INCLUDING SOFT MAGNETIC IRON ALLOY SHEET

(71) Applicant: Hitachi, Ltd., Tokyo (JP)

(72) Inventors: Tomohiro TABATA, Tokyo (JP); Shohei TERADA, Tokyo (JP); Yusuke ASARI, Tokyo (JP); Matahiro KOMURO, Tokyo (JP)

(21) Appl. No.: 18/850,388

(22) PCT Filed: Feb. 8, 2023
(86) PCT No.: PCT/JP2023/004079

§ 371 Date: Sep. 24, 2024

(30) Foreign Application Priority Data
Apr. 6, 2022 (JP) 2022-063322

(51) Int. Cl. C22C 38/10; C21D 6/00; C21D 6/04; C21D 9/46; C22C 33/04; C22C 38/00; C22C 38/12; C23C 8/26; H01F 1/18; H02K 1/02

(52) U.S. Cl. CPC C22C 38/10; C21D 6/007; C21D 6/04; C21D 9/46; C22C 33/04; C22C 38/001; C22C 38/12; C23C 8/26; H01F 1/18; H02K 1/02; C21D 2211/005; C22C 2202/02

(57) ABSTRACT

A soft magnetic iron alloy sheet having higher Bs and lower Pi than an electromagnetic pure iron sheet is capable of further reducing the cost as compared to Permendur. A method of manufacturing the soft magnetic iron alloy sheet, and an iron core and a rotating electric machine including the soft magnetic iron alloy sheet are provided. The soft magnetic iron alloy sheet includes 1 to 30 at % of Co, 0.5 to 10 at % of N, 0 to 1.2 at % of V, and a remainder consisting of Fe and impurities. The soft magnetic iron alloy sheet includes ferrite phase as a primary phase and iron nitride phase having a tetragonal structure. A tensile strain is generated in a range of 10% or more and 110% or less of a tensile elastic limit strain along an in-plane direction of the soft magnetic iron alloy sheet.

### TECHNICAL FIELD

The present invention relates to a technique of a soft magnetic material and particularly relates to a soft magnetic iron alloy sheet having a higher saturation magnetic flux density than an electromagnetic pure iron sheet, a method of manufacturing the soft magnetic iron alloy sheet, and an iron core and a rotating electric machine including the soft magnetic iron alloy sheet.

### BACKGROUND ART

As an iron core of an electromechanical device (for example, a rotating electric machine or a transformer), a laminated core where a plurality of sheets of a soft magnetic material such as an electromagnetic pure iron sheet or an electromagnetic steel sheet (for example, thickness: 0.01 to 1 mm) are laminated and molded is widely used. In the iron core, it is important to increase the conversion efficiency between electric energy and magnetic energy, and high magnetic flux density and low iron loss are important. In addition, there are a very wide variety of electromechanical devices including an iron core. Therefore, in order to satisfy various required characteristics for designing the electromechanical devices, techniques of stably manufacturing the soft magnetic material have been actively developed in the related art.

For example, PTL 1 (JP2005-272913A) discloses a high-strength non-oriented electromagnetic steel sheet that includes, as a component composition, by mass %, C: 0.02% or less, Si: 4.5% or less, Mn: 3.0% or less, Al: 3.0% or less, P: 0.50% or less, Cu: 0.6% or more and 1.1% or less, and a remainder consisting of Fe and unavoidable impurities, in which an increase in tensile strength before and after strain relief annealing is 50 MPa or more. In addition, the component composition may further include, by mass %, Ni: 3.0% or less and may further include one kind or two or more kinds selected from Sb, Sn, B, Ca, rare earth elements, and Co, in which each of Sb and Sn: 0.002 to 0.1%, each of B, Ca, and rare earth elements: 0.001 to 0.01%, and Co: 0.2 to 5.0%.

In PTL 1, Cu can be sufficiently dissolved in the steel during constant temperature holding of strain relief annealing by setting the Cu content added to the steel to be in a narrow appropriate range, and Cu can be finely precipitated in the process of cooling by performing cooling after the constant temperature holding under appropriate conditions. As a result, in the non-oriented electromagnetic steel sheet, improvement of magnetic characteristics obtained by removing residual strain during core processing and an increase in strength obtained by the fine precipitation process of Cu can be simultaneously achieved.

PTL 2 (JP2021-102799A) discloses a soft magnetic steel sheet including 1.2 at % or less of carbon, 9 at % or less of nitrogen, and the remainder consisting of iron and unavoidable impurities, a total concentration of the carbon and the nitrogen is 0.01 at % or more and 10 at % or less, a concentration of the nitrogen is higher than a concentration of the carbon, the soft magnetic steel sheet includes a phase (ferrite phase), α′ phase (FesN phase), α″ phase (Fe₁₆N₂ phase), and γ phase (austenite phase), the α phase is a primary phase, a volume fraction of the α″ phase is 10% or more, and a volume fraction of the γ phase is 5% or less.

PTL 2 describes that an iron-nitrogen-based martensite soft magnetic steel sheet having a higher saturation magnetic flux density than pure iron can be provided. In addition, by using the soft magnetic steel sheet, an iron core and a rotating electric machine having a higher conversion efficiency between electric energy and magnetic energy than an iron core formed of pure iron can be provided.

### CITATION LIST

### Patent Literature

PTL 1: JP2005-272913A
PTL 2: JP2021-102799A

### SUMMARY OF INVENTION

### Technical Problem

For an increase in output/an increase in torque of the rotating electric machine, it is important to increase a saturation magnetic flux density Bs of the soft magnetic material forming the iron core, and for an increase in efficiency/a reduction in size, it is important to suppress loss (iron loss Pi) of the soft magnetic material. Pi is the sum of hysteresis loss and eddy current loss, it is desirable that a coercive force Hc is low to reduce the hysteresis loss, and an increase in electrical resistance or a reduction in thickness is effective for reducing the eddy current loss.

It is said that magnetic characteristics of a commercially available electromagnetic pure iron sheet are Bs≈2.1 T. The iron core in the electromagnetic pure iron sheet is advantageous in high Bs and low material cost, but is disadvantageous in that Pi is likely to increases because Hc is relatively high at about 80 A/m and the electrical resistivity is low. The electromagnetic steel sheet including Si as in PTL 1 is advantageous in that the mechanical strength is higher than that of electromagnetic pure iron sheet and Pi is low, but is disadvantageous in that Bs is lower than that of the electromagnetic pure iron sheet. The soft magnetic steel sheet of PTL 2 is advantageous in that Bs is higher than that of the electromagnetic pure iron sheet and Hc is lower than or equal to that of the electromagnetic pure iron sheet, but is disadvantageous in that Pi is likely to increase because the α′ phase or the α″ phase has high magnetic crystalline anisotropy.

As an iron-based material having higher Bs and lower Hc than the electromagnetic pure iron sheet, a Fe—Co-based material is known. As the Fe—Co-based material, Permendur (49Fe-49Co-2V mass %=50Fe-48Co-2V at %) is a material having the highest Bs (about 2.4 T) among currently commercially available soft magnetic bulk materials. Note that the material cost of Co varies depending on market conditions but is 100 to 200 times higher than the material cost of Fe. Therefore, Permendur is disadvantageous in that the material cost is high. In addition, Permendur has a little difficulty in workability and thus is also disadvantageous in that the processing cost is likely to be high. When the Co content decreases, the material cost can decrease correspondingly, and the workability is also improved. However, unfortunately, Bs that is the largest advantage also decreases.

Recently, for the rotating electric machine or the transformer, an increase in output/an increase in torque and an increase in efficiency/a reduction in size have been very strongly required, and it has been more strongly required to simultaneously achieve Bs improvement and low Pi of the soft magnetic material as compared to the related art. On the other hand, of course, a reduction in the cost of the soft magnetic material is one of important issues.

Accordingly, an object of the present invention is to provide a soft magnetic iron alloy sheet having higher Bs and lower Pi than an electromagnetic pure iron sheet and capable of further reducing the cost as compared to Permendur, a method of manufacturing the soft magnetic iron alloy sheet, and an iron core and a rotating electric machine including the soft magnetic iron alloy sheet.

### Solution to Problem

(I) According to one aspect of the present invention, there is provided a soft magnetic iron alloy sheet including, as a chemical composition, 1 at % or more and 30 at % or less of Co (cobalt), 0.5 at % or more and 10 at % or less of N (nitrogen), 0 at % or more and 1.2 at % or less of V (vanadium), and a remainder consisting of Fe (iron) and impurities,
in which the soft magnetic iron alloy sheet includes ferrite phase as a primary phase and iron nitride phase (FesN phase and/or Fe₁₆N₂ phase) having a tetragonal structure, and
a tensile strain is generated in a range of 10% or more and 110% or less of a tensile elastic limit strain along an in-plane direction of the soft magnetic iron alloy sheet.

In the present invention, in the above-described soft magnetic iron alloy sheet (I) according to the present invention, the following improvements or changes can be made.
(i) A saturation magnetic flux density is more than 2.20 T, and an iron loss under conditions of a magnetic flux density of 1.0 T and 400 Hz (Pi_{-1.0/400}) is 25 W/kg or less.
(ii) An electrical insulating film having an average linear expansion coefficient lower than an average linear expansion coefficient of the soft magnetic iron alloy sheet is formed on both main surfaces of the soft magnetic iron alloy sheet.
(II) According to another aspect of the present invention there is provided a method of manufacturing a soft magnetic iron alloy sheet, the method including:
a starting material preparation step of preparing a starting material having a thickness of 0.01 mm or more and 1 mm or less that is formed of a soft magnetic material including Fe as a main component and including 1 at % or more and 30 at % or less of Co and 0 at % or more and 1.2 at % or less of V;
an iron nitride-formed iron alloy sheet preparation step of heating the starting material to an austenite formation temperature range in an ammonia gas atmosphere such that 0.5 at % or more and 10 at % or less of N penetrates and is diffuse into the starting material, and preparing an iron nitride-formed iron alloy sheet where austenite phase is transformed into martensite structure and iron nitride phase having a tetragonal structure is formed;
an elastic strain-experienced iron alloy sheet preparation step of applying a tensile stress in a tensile elastic limit range in an in-plane direction of the iron nitride-formed iron alloy sheet to prepare an elastic strain-experienced iron alloy sheet; and
a tensile strain-maintained iron alloy sheet preparation step of preparing an elastic strain-maintained iron alloy sheet where a predetermined amount of tensile strain is maintained in the in-plane direction of the elastic strain-experienced iron alloy sheet,
in which the tensile strain-maintained iron alloy sheet preparation step is controlled such that a tensile strain in a range of 10% or more and 110% or less of a tensile elastic limit strain of the iron nitride-formed iron alloy sheet is maintained.

In the present invention, in the above-described method of manufacturing the soft magnetic iron alloy sheet (II) according to the present invention, the following improvements or changes can be made.
(iii) The method further includes a tempering step of heating the soft magnetic iron alloy sheet at 90° C. or higher and 200° C. or lower for tempering, and the tempering step is performed before, during, or after the elastic strain-experienced iron alloy sheet preparation step.
(iv) The tensile strain-maintained iron alloy sheet preparation step is a step of forming an electrical insulating film having an average linear expansion coefficient lower than an average linear expansion coefficient of the iron nitride-formed iron alloy sheet on both main surfaces of the elastic strain-experienced iron alloy sheet.
(v) The tensile strain-maintained iron alloy sheet preparation step is a step of fixing using a fixing tool in a state where a tensile strain is applied in the in-plane direction of the elastic strain-experienced iron alloy sheet to be in a range of 10% or more and 110% or less of a tensile elastic limit strain of the iron nitride-formed iron alloy sheet.
(III) According to still another aspect of the present invention, there is provided an iron core that is formed of a laminate of soft magnetic iron alloy sheets,
in which the soft magnetic iron alloy sheet is the above-described soft magnetic iron alloy sheet according to the present invention.
(IV) According to still another aspect of the present invention, there is provided a rotating electric machine including an iron core,
in which the iron core is the above-described iron core according to the present invention.

### Advantageous Effects of Invention

According to the present invention, it is possible to provide a soft magnetic iron alloy sheet having higher Bs and lower Pi than an electromagnetic pure iron sheet and capable of further reducing the cost as compared to Permendur, a method of manufacturing the soft magnetic iron alloy sheet, and an iron core and a rotating electric machine including the soft magnetic iron alloy sheet.

### BRIEF DESCRIPTION OF DRAWINGS

FIG. 1 is a process drawing illustrating an example of a method of manufacturing a soft magnetic iron alloy sheet according to the present invention.

FIG. 2A is a perspective schematic view illustrating an example of a stator of a rotating electric machine.

FIG. 2B is an enlarged schematic cross-sectional view illustrating a slot region of the stator.

FIG. 3 is a schematic front view illustrating an example of the soft magnetic iron alloy sheet according to the present invention that is an iron alloy sheet for a stator core.

FIG. 4 is a graph showing a relationship between a tensile stress and an iron loss Pi_{-1.0/400}.

### DESCRIPTION OF EMBODIMENTS

[Fundamental Idea of Present invention]

As a fundamental idea of the present invention, the present inventors thought that the Co content is reduced to be less than that of Permendur to reduce the material cost and iron nitride phase (α′ phase or α″ phase) having a tetragonal structure is formed to compensate for a decrease in Bs caused by the reduction in the Co content. However, the α′ phase or the α″ phase has high magnetic crystalline anisotropy such that Hc or Pi is likely to increase. Accordingly, the present inventors repeated a thorough investigation on a technique of achieving a lower Pi in an iron alloy sheet where the α′ phase or the α″ phase is dispersed and formed in the matrix. As a result, it was found that, when a tensile strain is applied to the iron alloy sheet in an in-plane direction, Pi dramatically decreases. The present invention has been completed based on the finding.

Hereinafter, an embodiment of the present invention will be described in detail according to a manufacturing procedure with reference to the drawings. Note that the present invention is not limited to the embodiment described herein and can be appropriately combined with a well-known technique or can be improved based on a well-known technique within a range not departing from the technical idea of the present invention.

### [Method of Manufacturing Soft Magnetic Iron Alloy Sheet According to Present Invention]

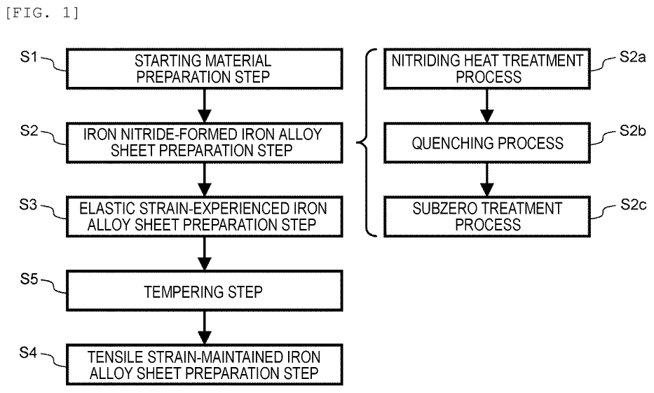

FIG. 1 is a process drawing illustrating an example of a method of manufacturing a soft magnetic iron alloy sheet according to the present invention. As illustrated in FIG. 1, schematically, the method of manufacturing the soft magnetic iron alloy sheet according to the present invention includes a starting material preparation step S1, an iron nitride-formed iron alloy sheet preparation step S2, an elastic strain-experienced iron alloy sheet preparation step S3, and a tensile strain-maintained iron alloy sheet preparation step S4. In addition, it is preferable to further perform a tempering step S5, and the step S5 may be performed before the step S3, during the step S3, or after the step S3. Hereinafter, each of the steps will be described in more detail.

### (Starting Material Preparation Step S1)

In the present step S1, as a starting material, a thin sheet material (thickness: 0.01 mm or more and 1 mm or less) including Fe as a main component (a component having the maximum content), 1 at % or more and 30 at % or less of Co, 0 at % or more and 1.2 at % or less of V, and impurities is prepared. The means of the starting material preparation step S1 is not particularly limited, and a well-known method can be appropriately used. A commercially available product may be used.

By adjusting the Co content to be 30 at % or less, the material cost can be significantly reduced as compared to Permendur. From the viewpoint of ensuring excellent Bs, the lower limit of the Co content is more preferably 5 at % or more and still more preferably 10 at % or more. In addition, from the viewpoint of reducing the material cost, the upper limit of the Co content is more preferably 25 at % or less and still more preferably 20 at % or less.

Although it is not an essential component, the V component has an effect of improving the workability in a Fe—Co-based material and thus may be included in an amount that is less than 4% with respect to the Co content (for example, when Co=30 at %, V≤1.2 at %).

The impurities (impurities that may be included in the starting material, for example, H (hydrogen), B (boron), C (carbon), Si (silicon), P (phosphorus), S (sulfur), Ti (titanium), Cr (chromium), Mn (manganese), Ni (nickel), Cu (copper), or Nb (niobium)) are allowed within a range (for example, total concentration: 2 at % or less) where there are no adverse effects on the Bs of the soft magnetic iron alloy sheet.

### (Iron Nitride-Formed Iron Alloy Sheet Preparation Step S2)

The iron nitride-formed iron alloy sheet preparation step S2 includes a nitriding heat treatment process S2a of penetrating and diffusing N atoms into the sheet material of the prepared starting material up to a desired N content, a quenching process S2b of transforming austenite phase into martensite structure and forming iron nitride phase having a tetragonal structure, and a subzero treatment process S3c for transforming residual austenite phase into martensite structure.

In the nitriding heat treatment process S2a, N atoms are penetrated and diffused from both main surfaces of the starting material until the N concentration reaches a predetermined concentration in an environment of a temperature of 500° C. or higher and 1200° C. or lower (for example, austenite (γ phase) formation temperature range) and a NH₃ (ammonia) gas atmosphere. As the NH₃ gas atmosphere, mixed gas of NH₃ gas and N₂ gas, mixed gas of NH₃ gas and Ar gas, or mixed gas of NH₃ gas and H₂ gas can be suitably used.

The N content (average content in the entire iron alloy sheet) in the nitriding heat treatment process S2a is preferably 0.5 at % or more and 10 at % or less. By setting the N content to be 0.5 at % or more, a significant amount of desired iron nitride phase (FesN phase (α′ phase) and/or Fe₁₆N₂ phase (α″ phase)) is formed to contribute to improvement of Bs. By setting the N content to be 10 at % or less, the formation of undesired iron nitride phase (for example, Fe₄N phase (γ′ phase) or Fe₃N phase (ε phase)) can be suppressed. The lower limit of the N content is more preferably 0.7 at % or more and still more preferably 1 at % or more. In addition, the upper limit of the N content is more preferably 5 at % or less and still more preferably 3 at % or less.

It is preferable to introduce NH₃ gas after the temperature reaches 500° C. or higher. The reason for this is that, when NH₃ gas is actively introduced in a stable temperature range of ferrite phase (a phase), an undesired iron nitride phase (for example, Fe₄N phase or Fe₃N phase) is more likely to be formed than desired iron nitride phase having a tetragonal structure (FesN phase and/or Fe₁₆N₂ phase).

After the nitriding heat treatment process S2a, the quenching process S2b of rapid cooling to 100° C. or lower to transform austenite phase (γ phase) into a martensite structure and to form desired iron nitride phase (Fe₈N phase and/or Fe₁₆N₂ phase). As long as an average cooling rate of 100° C./s or faster is implemented, a rapid cooling method is not particularly limited, water cooling, oil cooling, or gas cooling in the related art can be appropriately used.

Due to the quenching process S2b, most of γ phase can be transformed into martensite structure, but a part of the γ phase may remain (residual γ phase). Since the γ phase is nonmagnetic, it is preferable that a volume fraction of the residual γ phase is 5% or less from the viewpoint of magnetic characteristics.

Accordingly, after the quenching process S2b, the subzero treatment S2c for transforming the residual γ phase into martensite structure may be performed. The subzero treatment is a treatment of cooling the iron alloy sheet to 0° C. or lower, and a normal subzero treatment using dry ice or a super subzero treatment using liquid nitrogen can be preferably used. The subzero treatment S2c is not an essential process but is preferably performed from the viewpoint of magnetic characteristics.

### (Elastic Strain-Experienced Iron Alloy Sheet Preparation Step S3)

The elastic strain-experienced iron alloy sheet preparation step S3 is a step of applying a tensile stress in a tensile elastic limit range in an in-plane direction of the iron nitride-formed iron alloy sheet to prepare an elastic strain-experienced iron alloy sheet. The in-plane direction refers to a direction orthogonal to a thickness direction of the iron alloy sheet.

The tensile stress of the tensile elastic limit may be acquired from a stress-strain curve that is obtained by sampling a part of the iron nitride-formed iron alloy sheet prepared in the previous step S2 and performing stress-strain measurement in a tensile test. At this time, it is preferable to acquire the strain of the tensile elastic limit together. The tensile stress to be applied is preferably 10% or more and less than 100% of the tensile elastic limit stress and more preferably 20% or more and 70% or less of the tensile elastic limit stress. A method for a tensile load is not particularly limited, and a method in the related art may be used. When a mass production line is assumed, for example, a method of interposing a workpiece between two pairs of rolls to prevent slippage and applying a tension between the two pairs of rolls while letting the workpiece to slowly flow is considered.

It is preferable that the present step S3 is performed at 200° C. or lower. When the temperature is higher than 200° C., undesired iron nitride phase (for example, Fe₄N phase or Fe₃N phase) is more likely to be formed. The lower limit temperature is not particularly limited, but it is not necessary to spend the cost for cooling. Therefore, the room temperature/air temperature is the lower limit. In addition, the holding time of the tensile load may be appropriately set in consideration of the volume/heat capacity of the workpiece but is preferably set to be within 24 hours from the viewpoint of the processing cost.

In the present step S3, by generating a mechanical strain in crystal grains/crystal lattice forming the iron nitride-formed iron alloy sheet, an effect of facilitating the diffusion/rearrangement of Fe atoms and N atoms to promote the formation of desired iron nitride phase (FesN phase and/or Fe₁₆N₂ phase) is obtained. Note that, since the tensile load is in the elastic limit range, there is no change in external appearance after performing the present step S3.

### (Tempering Step S5)

The tempering step S5 is a step of heating the iron nitride-formed iron alloy sheet or the elastic strain-experienced iron alloy sheet at a temperature of 90° C. or higher and 200° C. or lower for tempering. The present step S5 is not an essential step but is preferably performed from the viewpoint of imparting excellent toughness to the iron alloy sheet and the iron core including the iron alloy sheet. When the heating temperature is higher than 200° C., undesired iron nitride phase (for example, Fe₄N phase or Fe₃N phase) is more likely to be formed. When the heating temperature is lower than 90° C., only the tempering effect becomes insufficient and particular malfunctions do not occur. The present step S5 may be performed between the step S2 and the step S3, immediately after the step S3, or during the step S3.

### (Tensile Strain-Maintained Iron Alloy Sheet Preparation Step S4)

The tensile strain-maintained iron alloy sheet preparation step S4 is a step of preparing an elastic strain-maintained iron alloy sheet where a predetermined amount of tensile strain is maintained in the in-plane direction of the elastic strain-experienced iron alloy sheet or the tempered elastic strain-experienced iron alloy sheet. As long as the state where the tensile strain in the in-plane direction is applied to the elastic strain-experienced iron alloy sheet or the tempered elastic strain-experienced iron alloy sheet can be maintained/fixed, for example, the following method can be used without any particular limitation.

The method is forming an electrical insulating film having an average linear expansion coefficient lower than an average linear expansion coefficient of the iron nitride-formed iron alloy sheet on both main surfaces of the elastic strain-experienced iron alloy sheet. An electrical insulating ceramic film (for example, a TiN film or an SiO₂ film) having a lower average linear expansion coefficient than the iron alloy sheet is formed on both main surfaces of the heated iron alloy sheet using a chemical vapor deposition method (CVD method) or a physical vapor deposition method (PVD method). When the electrical insulating film is cooled after the formation, a compressive stress is applied to the electrical insulating film due to a difference in an average linear expansion coefficient, and a tensile stress is applied to the iron alloy sheet. In general, the ceramic material is brittle to tensile stress but is very rigid for compressive stress. Therefore, the state where the tensile strain in the in-plane direction is applied to the iron alloy sheet can be maintained/fixed.

In order to adjust the tensile strain of the iron alloy sheet, the electrical insulating film may be formed in a state where the tensile stress is applied to the iron alloy sheet.

Another method is fixing using a fixing tool (for example, a fixing plate or a bolt) in a state where a tensile strain is applied to be in a range of 10% or more and 110% or less of a tensile elastic limit strain of the iron nitride-formed iron alloy sheet. This method is one method suitable for assembling a laminated core.

Through the above-described steps, the soft magnetic iron alloy sheet according to the present invention can be manufactured. Although the details will be described below, in the obtained soft magnetic iron alloy sheet, a saturation magnetic flux density is more than 2.20 T, and an iron loss under conditions of a magnetic flux density of 1.0 T and 400 Hz is 25 W/kg or less. This way, higher Bs and lower Pi than those of the electromagnetic pure iron sheet can be exhibited. In addition, when the tensile strain of the step S4 is adjusted (for example, when the tensile strain is controlled and maintained to be 25% or more and 100% or less of the tensile elastic limit strain), the iron loss can be reduced to be 20 W/kg or less. This iron loss is at the level equivalent to that of an Si-containing electromagnetic steel sheet. Further, since the Co content is lower than that of Permendur, the cost can be further reduced as compared to Permendur.

[Iron Core and Rotating Electric Machine including Soft Magnetic Iron Alloy Sheet according to Present Invention]

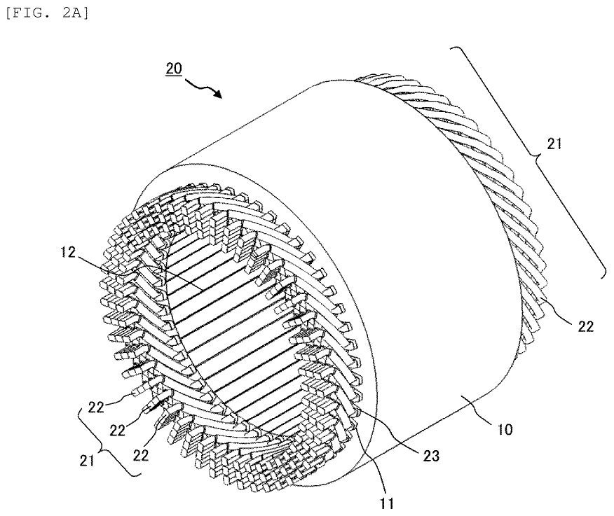

FIG. 2A is a perspective schematic view illustrating an example of a stator of a rotating electric machine, and FIG. 2B is an enlarged schematic cross-sectional view illustrating a slot region of the stator. The cross-section refers to a cross-section orthogonal to a rotating axis direction (a cross-section of which the normal line is parallel to the axis direction). In the rotating electric machine, a rotor (not illustrated) is disposed radially inside the stator illustrated in FIGS. 2A and 2B.

As illustrated in FIGS. 2A and 2B, in a stator 20, a stator coil 21 is wound around a plurality of stator slots 11 formed in an inner circumferential side of an iron core 10. The stator slots 11 are arranged and formed at predetermined pitches in a circumferential direction of the iron core 10, are spaces that penetrate and are formed in the axis direction, and include slits 12 that are formed in the outermost circumferential portions to extend in the axis direction. Regions that divide the stator slots 11 adjacent to each other will be referred to as teeth 13 of the iron core 10, and portions that define the slits 12 in inner circumferential side tip regions of the teeth 13 will be referred to as teeth claw portions 14.

The stator coil 21 is typically formed of a plurality of segment conductors 22. For example, in FIGS. 2A and 2B, the stator coil 21 is formed of three segment conductors 22 corresponding to U phase, V phase, and W phase of three-phase currents. In addition, from the viewpoint of preventing partial discharge between the segment conductors 22 and the iron core 10 and partial discharge between the respective phases (U phase, V phase, and W phase), typically, an outer circumference of each of the segment conductors 22 is covered with an electrical insulating material 23 (for example, insulating paper or enamel coating).

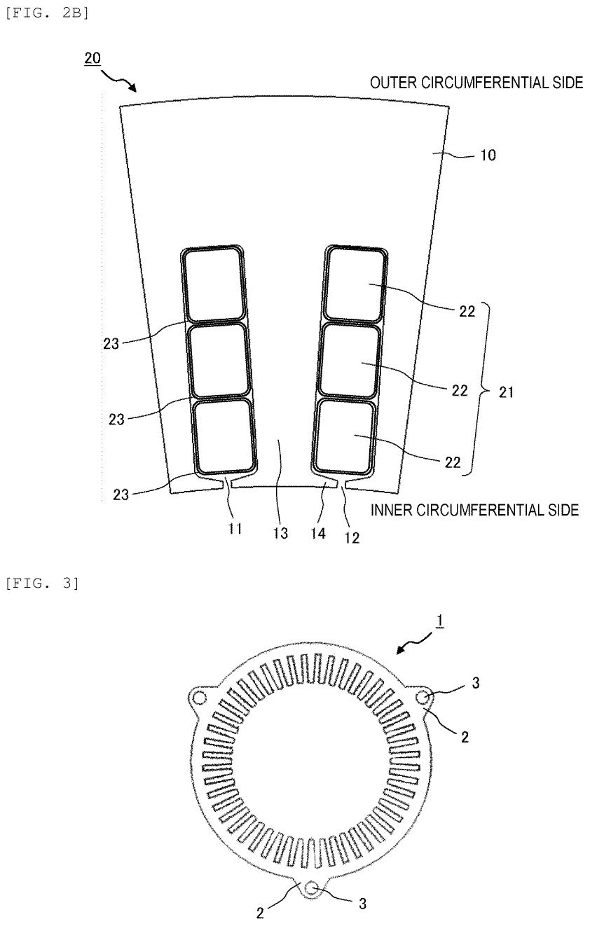

FIG. 3 is a schematic front view illustrating an example of the soft magnetic iron alloy sheet according to the present invention that is an iron alloy sheet for a stator core. In a soft magnetic iron alloy sheet 1 illustrated in FIG. 3, a protrusion portion (tang) 2 is provided at three positions at intervals of 120° on the outer circumference, and a fixing hole 3 is formed in each of the tangs 2. When the laminated core according to the present invention is assembled, for example, for each of the soft magnetic iron alloy sheets 1, each of the tangs 2 is held with a jig, and while uniformly expanding the soft magnetic iron alloy sheet 1 toward the radially outside in the range of the tensile elastic strain, a bolt (not illustrated) standing on a fixing plate (not illustrated) is fitted into the fixing hole 3. As a result, the soft magnetic iron alloy sheets 1 can be laminated and fixed in a state where the tensile strain is applied.

The number of the tangs 2 is not limited to “three positions at intervals of 120°” as illustrated in FIG. 3, and may be “four positions at intervals of 90°”, “six positions at intervals of 60°”, or more. In addition, the soft magnetic iron alloy sheet according to the present invention is not limited to an iron alloy sheet for a stator core and is also applicable to an iron alloy sheet for a rotor core.

The rotating electric machine according to the present invention is a rotating electric machine including the iron core 10 according to the present invention. The iron core 10 according to the present invention has higher Bs than an iron core formed of an electromagnetic pure iron sheet in the related art, which leads to an increase in torque/an increase in output of the rotating electric machine. The iron core 10 according to the present invention has lower Pi than an iron core formed of an electromagnetic pure iron sheet in the related art, which leads to an increase in efficiency/a reduction in size of the rotating electric machine. In addition, the iron core 10 according to the present invention can further reduce the cost as compared to an iron core formed of Permendur. Therefore, an excessive cost increase of the rotating electric machine can be suppressed.

### EXAMPLES

Hereinafter, the present invention will be described in more detail using various experiments. Note that the present invention is not limited configurations and structures described in the experiments.

### Experiment 1

### (Preparation of Starting Material 1, Reference Sample 1, and Reference Sample 2)

Commercially available pure metal raw materials (Fe and Co, purity thereof=99.9%) were mixed, dissolved in an alumina crucible through a high frequency melting method (manufactured by Sk Medical Electronics Co., Ltd., high frequency melting furnace MU-αIV, in a reduced pressure AR atmosphere), and poured into a copper mold to prepare an alloy ingot. Next, the sample was annealed in a vacuum to homogenize the alloy ingot. The obtained alloy ingot was cut and rolled to prepare an Fe-20 at %-Co alloy sheet (nominal compositions, thickness: =0.1 mm) as a starting material 1.

The starting material 1 was annealed to remove processing distortion in an Ar gas atmosphere (0.8×10⁵ Pa) at 500° C. to prepare Reference Sample 1. Reference Sample 1 is a sample on which the iron nitride-formed iron alloy sheet preparation step was not performed, and is a reference for evaluating the influence of the iron nitride phase formation.

In addition, a commercially available electromagnetic steel sheet (thickness=0.35 mm, 35H300, manufactured by Nippon Steel Corporation) was separately prepared as a Reference Sample 2. Reference Sample 2 is an Si-containing electromagnetic steel sheet, and is a reference for related art/commercially available products having low Pi.

### Experiment 2

### (Preparation of Iron Nitride-Formed Iron Alloy Sheet)

As the iron nitride-formed iron alloy sheet preparation step, the starting material 1 prepared in Experiment 1 was increased to 600° C. in an N₂ gas atmosphere (0.8×10⁵ Pa), and was held in this state for 30 minutes. Next, after converting the atmosphere into a NH₃ gas atmosphere (0.8×10⁵ Pa), N atoms were penetrated and diffused such that the N content was about 1.1 at %, and water quenching (20° C.) was performed. Next, by performing a super subzero treatment of immersing the sample material in liquid nitrogen within 5 minutes, an iron nitride-formed iron alloy sheet based on the starting material 1 was prepared.

### Experiment 3

### (Stress-Strain Measurement in Tensile Test)

The stress and the strain of the tensile elastic limit were acquired from a stress-strain curve that was obtained by sampling Reference Samples 1 and 2 and the iron nitride-formed iron alloy sheets prepared in the Experiments 1 and 2 and performing stress-strain measurement in a tensile test. The results are shown in Table 1.

TABLE 1
Measurement Results of Stress and Strain of Tensile
Elastic Limit of Reference Samples 1 to 2 and
Iron Nitride-Formed Iron Alloy Sheet

| | Tensile Elastic | Tensile Elastic |
|---|---|---|
| | Limit Stress (MPa) | Limit Strain |
| Reference Sample 1 | 80 | 0.0018 |
| Reference Sample 2 | 200 | 0.0034 |
| Iron Nitride-Formed | 150 | 0.00065 |
| Iron Alloy Sheet | | |

As illustrated in Table 1, Reference Sample 2 of the Si-containing electromagnetic steel sheet has a relatively high mechanical strength and has an elastic deformation region having a stress of 200 MPa and a strain of 0.0034. Reference Sample 1 having the chemical composition of the starting material 1 on which the iron nitride-formed iron alloy sheet preparation step was not performed has a relatively low mechanical strength and has an elastic deformation region having a stress of 80 MPa and a strain of 0.0018. On the other hand, in the iron nitride-formed iron alloy sheet, the iron nitride phase was dispersed and formed. As a result, the mechanical strength and the elastic modulus were further improved as compared to Reference Sample 1, and an elastic deformation region having a stress of 150 MPa and a strain of 0.00065 was present.

### Experiment 4

### Preparation of Example 1

The iron nitride-formed iron alloy sheet prepared in Experiment 2 was held for 1 hour while applying a tensile stress of 100 MPa in the in-plane direction as the elastic strain-experienced iron alloy sheet preparation step S3. The obtained iron alloy sheet was prepared as Example 1. In this manufacturing process, the tempering step S5 was not performed.

### Experiment 5

### Preparation of Example 2

The same elastic strain-experienced iron alloy sheet preparation step S3 as that of Experiment 4 was performed on the iron nitride-formed iron alloy sheet prepared in Experiment 2. Next, the tempering step S5 of holding the iron alloy sheet at 90° C. for 24 hours was performed. This manufacturing process corresponds to the process of performing the tempering step S5 after the elastic strain-experienced iron alloy sheet preparation step S3. The obtained iron alloy sheet was prepared as Example 2.

### Experiment 6

### Preparation of Example 3

The tempering step S5 of holding at 90° C. for 24 hours was performed on the iron nitride-formed iron alloy sheet prepared in Experiment 2. Next, the same elastic strain-experienced iron alloy sheet preparation step S3 as that of Experiment 4 was performed. This manufacturing process corresponds to the process of performing the tempering step S5 before the elastic strain-experienced iron alloy sheet preparation step S3. The obtained iron alloy sheet was prepared as Example 3.

### Experiment 7

### Preparation of Example 4

The iron nitride-formed iron alloy sheet prepared in Experiment 2 was held for 24 hours while applying a tensile stress of 100 MPa in the in-plane direction in an environment heated to 90° C. This manufacturing process corresponds to the process of performing the tempering step S5 during the elastic strain-experienced iron alloy sheet preparation step S3. The obtained iron alloy sheet was prepared as Example 4.

### Experiment 8

### (Investigation of Characteristics)

Regarding Reference Samples 1 and 2 and Examples 1 to 4 prepared in Experiments 1 and 4 to 7, wide angle X-ray diffraction (WAXD) using Cu-Kα rays was performed using an X-ray diffractometer (Rint-Ultima III, manufactured by Rigaku Corporation) to identify the crystal phases. As a result, in Reference Sample 1 and Reference Sample 2, a diffraction peak of only the ferrite phase (a phase) was verified. On the other hand, in Examples 1 to 4, not only a diffraction peak of the α phase as a primary phase but also a diffraction peak of the FesN phase and/or the Fe₁₆N₂ phase were verified.

### (Measurement of Magnetic Characteristics)

Regarding Reference Samples 1 and 2 and Examples 1 to 4, magnetic characteristics (Bs, Hc, and Pi) were measured. Using a vibrating sample magnetometer (manufactured by Riken Denshi Co., Ltd., BHV-525V), the magnetization of the sample (unit: emu) was measured under conditions of magnetic field: 1.6 MA/m and temperature: 20° C. to obtain a saturation magnetic flux density Bs (unit: T) and a coercive force Hc (unit: A/m) from the sample volume and the sample mass. In addition, with an H coil method (according to JIS C 2556:2015) using a BH loop analyzer (manufactured by IFG Corporation, IF-BH550) and a vertical yoke single sheet tester, iron loss Pi_{-1.0/400} (unit: W/kg) of the sample was measured under conditions of magnetic flux density: 1.0 T, 400 Hz, and temperature: 20° was measured. The results are shown in Table 2.

TABLE 2
Measurement Results of Magnetic Characteristics
of Reference Samples 1 and 2 and Examples 1 to 4

| | BS (T) | HC (A/m) | Pi_{-10/400} (W/kg) |
|---|---|---|---|
| Reference Sample 1 | 2.31 | 111 | 27.9 |
| Reference Sample 2 | 2.01 | 61.9 | 17.6 |
| Example 1 | 2.40 | 152 | 32.2 |
| Example 2 | 2.40 | 153 | 32.3 |
| Example 3 | 2.42 | 136 | 30.5 |
| Example 4 | 2.41 | 165 | 32.5 |

As described above, Reference Sample 1 is a sample having the chemical composition of the starting material 1 on which the iron nitride-formed iron alloy sheet preparation step S2 was not performed. It was verified that, since the Co content of the starting material 1 was less than the Co content of Permendur, Bs of the starting material 1 was lower than Bs (about 2.4 T) of Permendur. It was found from the many experiments of the present inventors that, when there is a difference of 0.03 T or more in Bs, this difference can be said to be a clear difference/a significant difference.

Reference Sample 2 is an Si-containing electromagnetic steel sheet, and is a reference for related art/commercially available products having Pi lower than that of an electromagnetic pure iron sheet. It was verified that, although Hc and Pi were low, Bs was lower than that of an electromagnetic pure iron sheet.

On the other hand, in Examples 1 to 4 according to the present invention, due to the formation of the desired iron nitride phase (FesN phase and/or Fe₁₆N₂ phase), Bs was clearly improved, and Bs was more than or equal to that of Permendur. On the other hand, it was verified that, due to an increase in magnetic crystalline anisotropy caused by the formation of the iron nitride phase, Hc was clearly increased and Pi_{-1.0/400} was also increased as compared to Reference Sample 1.

It was verified from a comparison between Examples 1 to 4 that “whether to perform the tempering step S5” or “the order of the elastic strain-experienced iron alloy sheet preparation step S3 and the tempering step S5” in the manufacturing process has no particular influence on the magnetic characteristic.

### Experiment 9

(Inspection of Relationship between Tensile Stress and Iron Loss)

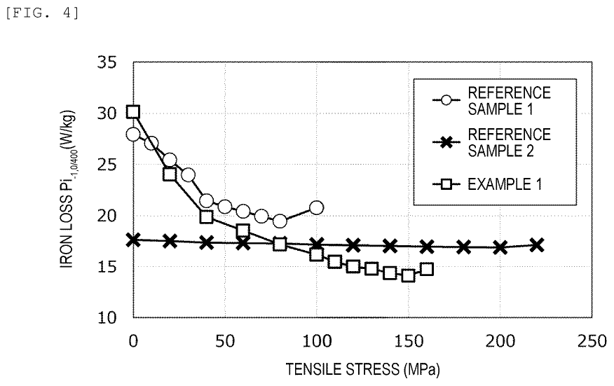

Using Reference Samples 1 and 2 and Example 1, a relationship between a tensile stress and iron loss was inspected. Specifically, the iron loss Pi_{-1.0/400} was measured while changing the tensile stress to be applied in the in-plane direction of the sample. The measurement of the iron loss Pi_{-1.0/400} was performed using the same method as that of Experiment 8. The results are illustrated in FIG. 4.

FIG. 4 is a graph showing a relationship between a tensile stress and an iron loss Pi_{-1.0/400}. As illustrated in FIG. 4, it was verified that, in Reference Sample 2, the Pi_{-1.0/400} did not substantially change depending on a change in tensile stress in the elastic deformation region (≤200 MPa), and when the elastic deformation region was exceeded (in a plastically deformed region, >200 MPa), the PI_{-1.0/400} was slightly increased.

It was verified that, in Reference Sample 1, when the tensile stress increased in the elastic deformation region (≤80 MPa), the Pi_{-1.0/400} was significantly decreased, and when the elastic deformation region was exceeded (in a plastically deformed region, >80 MPa), the PI_{-1.0/400} was rapidly increased. In Reference Sample 1, the elastic deformation region was relatively narrow, and thus the Pi_{-1.0/400} decreased but was not lower than the Pi_{-1.0/400} Of Reference Sample 2.

It was verified that, in Example 1, when the tensile stress increased in the elastic deformation region (≤150 MPa), the Pi_{-1.0/400} was significantly decreased, when the tensile stress was about 15 MPa or more (about 10% or more of the elastic limit), the Pi_{-1.0/400} was lower than the Pi_{-1.0/400} Of Reference Sample 1, when the tensile stress was about 20 MPa or more (about 13% or more of the elastic limit), Pi_{-1.0/400}≤25 W/kg, when the tensile stress was about 40 MPa or more (about 25% or more of the elastic limit), Pi-1.0/400≤20 W/kg, and when the tensile stress was about 75 MPa or more (about 50% or more of the elastic limit), the Pi_{-1.0/400} was decreased to be lower than the Pi_{-1.0/400} Of Reference Sample 2. Note that it was verified that, when the elastic deformation region was exceeded (in a plastically deformed region, >150 MPa), the PI_{-1.0/400} was increased as in the other samples.

Here, changes in Pi_{-1.0/400} depending on the application/the release of the tensile stress (tension) are collectively shown in Table 3.

TABLE 3
Change (W/kg) in Pi_{-10/400} depending on Application/Release
of Tensile Stress in Reference Samples 1 and 2 and Example 1

| | | | | | Tension |
|---|---|---|---|---|---|
| | | Tensile | | Plastic | Released |
| | Not | Limit | Tension | Deformation | after Plastic |
| | Applied | Applied | Released | Applied | Deformation |
| Reference | 27.9 | 19.4 | 27.9 | 20.7 | 31.1 |
| Sample 1 | | (80 MPa | | (100 MPa | |
| | | Applied) | | Applied) | |
| Reference | 17.6 | 16.9 | 17.6 | 17.1 | 19.8 |
| Sample 2 | | (200 MPa | | (220 MPa | |
| | | Applied) | | Applied) | |
| Example 1 | 30.1 | 14.1 | 30.1 | 14.7 | 36.2 |
| | | (150 MPa | | (160 MPa | |
| | | Applied) | | Applied) | |

As shown in Table 3, in “Not Applied-Elastic Limit Applied→Tension Released”, when the elastic limit was applied, Pi_{-1.0/400} of all the samples decreased, however, when the tension was not applied and when the tension was released, the Pi_{-1.0/400} did not change. Based on this result, it can be said that the change in Pi_{-1.0/400} depending on the tensile stress in the elastic deformation region is reversible. It can be seen that, in Example 1 according to the present invention, there is a large difference/change amount between the Pi_{-1.0/400} when the tension was not applied and the Pi_{-1.0/400} when the elastic limit was applied, which can be reduced to be half or less as compared to Reference Samples 1 and 2. In “Plastic Deformation Applied-Tension Released after Plastic Deformation”, in all the samples, the Pi_{-1.0/400} was increased as compared to that when the tension was not applied and that when the tension was released.

The mechanism for the Pi decrease caused by the application of the tensile stress is not completely clear but is presumed to be that the rotation of spin is facilitated due to the expansion of the crystal lattice caused by the stress application such that a decrease in magnetic crystalline anisotropy and promotion of domain wall displacement occur. On the other hand, the mechanism of the increase in Pi_{-1.0/400} when the tension is released after the plastic deformation is presumed to be that dislocation that newly occurs due to the plastic deformation functions as a barrier of the domain wall displacement.

### Experiment 10

### (Investigation on Method of Applying Tensile Stress)

As the method of applying and maintaining the tensile stress in the iron alloy sheet, not only a method of fixing a state where the iron alloy sheet was physically/mechanically pulled but also a method of forming a ceramic material film having an average linear expansion coefficient lower than an average linear expansion coefficient of the iron alloy sheet on both main surfaces of the iron alloy sheet can be used. As described above, when the ceramic material film is formed on both main surfaces of the heated iron alloy sheet and cooled, a compressive stress is applied to the ceramic material film due to a difference in average linear expansion coefficient, and a tensile stress is applied to the iron alloy sheet. In general, the ceramic material is brittle to tensile stress but is very rigid for compressive stress. Therefore, the state where the tensile strain in the in-plane direction is applied to the iron alloy sheet can be maintained/fixed.

When a case where a TiN film (average linear expansion coefficient: 9.3 ppm/K) is formed on both main surfaces of an iron alloy sheet (thickness: 0.1 mm, linear expansion coefficient at 1000° C.: 17 ppm/K, linear expansion coefficient at 500° C.: 15 ppm/K) is estimated, the results are as shown in Table 4. In consideration of the elastic modulus of TiN of 251 GPa, shrinkage of TiN caused by compressive stress is ignored.

TABLE 4
Estimation of Tensile Stress generated in Iron Alloy Sheet during
Formation of TiN Film on Both Main Surfaces of Iron Alloy Sheet

| | | | Tensile | | Tensile |
|---|---|---|---|---|---|
| | | Heat | Stress | Heat | Stress |
| TiN Film | Occupancy | Shrinkage | generated in | Shrinkage | generated in |
| Thickness | of Iron Alloy | Temperature | Iron Alloy | Temperature | Iron Alloy |
| (μm) | Sheet (%) | (° C.) | Sheet (MPa) | (° C.) | Sheet (MPa) |
| 0.5 | 99 | 1000 | 19 | 500 | 7 |
| 1 | 98 | | 38 | | 14 |
| 2 | 96 | | 77 | | 29 |
| 3 | 94 | | 115 | | 43 |
| 4 | 92 | | 153 | | 57 |

As shown in Table 4, it can be seen that, when the heat shrinkage temperature (a temperature difference from the room temperature during the formation of the film) is 1000° C., a sufficient tensile stress for decreasing Pi_{-1.0/400} can be generated in the iron alloy sheet in a TiN film thickness (single side) range of 0.5 to 4 μm. In addition, it can be seen that, when the heat shrinkage temperature is 500° C., a sufficient tensile stress for decreasing Pi_{-1.0/400} can be generated in the iron alloy sheet in a TiN film thickness (single side) range of 1 to 4 μm.

As clearly seen from the estimation of Table 4, it can be said that the method of forming a ceramic material film having an average linear expansion coefficient lower than an average linear expansion coefficient of the iron alloy sheet on both main surfaces of the iron alloy sheet is very prospective as the method of applying and maintaining the tensile stress in the iron alloy sheet.

The above-described embodiment and experimental examples have been described to help understanding of the present invention, and the present invention is not limited to the described specific configurations. For example, a part of the configuration of the embodiment can be replaced with a configuration of a common technical knowledge of a person skilled in the art. In addition, a configuration of a common technical knowledge of a person skilled in the art may be added to the configuration of the embodiment. That is, in the present invention, for a part of the configurations of the embodiment or the experimental example in the present specification, deletions, replacements with other configurations, and addition of other configurations can be made within a range not departing from the technical idea of the present invention.

### REFERENCE SIGNS LIST

10: laminated core
11: stator slot
12: slit
13: teeth
14: teeth claw portion
20: stator
21: stator coil
22: segment conductor
23: electrical insulating material
1: soft magnetic iron alloy sheet
2: protrusion portion (tang)
3: fixing hole

1. A soft magnetic iron alloy sheet comprising, as a chemical composition, 1 at % or more and 30 at % or less of Co, 0.5 at % or more and 10 at % or less of N, 0 at % or more and 1.2 at % or less of V, and a remainder consisting of Fe and impurities,
wherein the soft magnetic iron alloy sheet includes ferrite phase as a primary phase and iron nitride phase having a tetragonal structure, and
a tensile strain is generated in a range of 10% or more and 110% or less of a tensile elastic limit strain along an in-plane direction of the soft magnetic iron alloy sheet.

2. The soft magnetic iron alloy sheet according to claim 1,
wherein a saturation magnetic flux density is more than 2.20 T, and an iron loss under conditions of a magnetic flux density of 1.0 T and 400 Hz is 25 W/kg or less.

3. The soft magnetic iron alloy sheet according to claim 1,
wherein an electrical insulating film having a lower average linear expansion coefficient than the soft magnetic iron alloy sheet is formed on both main surfaces of the soft magnetic iron alloy sheet.

4. A method of manufacturing a soft magnetic iron alloy sheet, the method comprising:
a starting material preparation step of preparing a starting material having a thickness of 0.01 mm or more and 1 mm or less that is formed of a soft magnetic material including Fe as a main component and including 1 at % or more and 30 at % or less of Co and 0 at % or more and 1.2 at % or less of V;
an iron nitride-formed iron alloy sheet preparation step of heating the starting material to an austenite formation temperature range in an ammonia gas atmosphere such that 0.5 at % or more and 10 at % or less of N penetrates and is diffused into the starting material, and preparing an iron nitride-formed iron alloy sheet where austenite phase is transformed into martensite structure and iron nitride phase having a tetragonal structure is formed;
an elastic strain-experienced iron alloy sheet preparation step of applying a tensile stress in a tensile elastic limit range in an in-plane direction of the iron nitride-formed iron alloy sheet to prepare an elastic strain-experienced iron alloy sheet; and
a tensile strain-maintained iron alloy sheet preparation step of preparing an elastic strain-maintained iron alloy sheet where a predetermined amount of tensile strain is maintained in the in-plane direction of the elastic strain-experienced iron alloy sheet,
wherein the tensile strain-maintained iron alloy sheet preparation step is controlled such that a tensile strain in a range of 10% or more and 110% or less of a tensile elastic limit strain of the iron nitride-formed iron alloy sheet is maintained.

5. The method of manufacturing the soft magnetic iron alloy sheet according to claim 4, further comprising a tempering step of heating the iron alloy sheet at 90° C. or higher and 200° C. or lower for tempering,
wherein the tempering step is performed before, during, or after the elastic strain-experienced iron alloy sheet preparation step.

6. The method of manufacturing the soft magnetic iron alloy sheet according to claim 4, wherein the tensile strain-maintained iron alloy sheet preparation step is a step of forming an electrical insulating film having an average linear expansion coefficient lower than an average linear expansion coefficient of the iron nitride-formed iron alloy sheet on both main surfaces of the elastic strain-experienced iron alloy sheet.

7. The method of manufacturing the soft magnetic iron alloy sheet according to claim 4, wherein the tensile strain-maintained iron alloy sheet preparation step is a step of fixing using a fixing tool in a state where a tensile strain is applied in the in-plane direction of the elastic strain-experienced iron alloy sheet to be in a range of 10% or more and 110% or less of a tensile elastic limit strain of the iron nitride-formed iron alloy sheet.

8. An iron core that is formed of a laminate of soft magnetic iron alloy sheets, wherein the soft magnetic iron alloy sheet is the soft magnetic iron alloy sheet according to claim 1.

9. A rotating electric machine comprising an iron core,
wherein the iron core is the iron core according to claim 8.

10. The soft magnetic iron alloy sheet according to claim 2,
wherein an electrical insulating film having a lower average linear expansion coefficient than the soft magnetic iron alloy sheet is formed on both main surfaces of the soft magnetic iron alloy sheet.

11. The method of manufacturing the soft magnetic iron alloy sheet according to claim 5,
wherein the tensile strain-maintained iron alloy sheet preparation step is a step of forming an electrical insulating film having an average linear expansion coefficient lower than an average linear expansion coefficient of the iron nitride-formed iron alloy sheet on both main surfaces of the elastic strain-experienced iron alloy sheet.

12. The method of manufacturing the soft magnetic iron alloy sheet according to claim 5,
wherein the tensile strain-maintained iron alloy sheet preparation step is a step of fixing using a fixing tool in a state where a tensile strain is applied in the in-plane direction of the elastic strain-experienced iron alloy sheet to be in a range of 10% or more and 110% or less of a tensile elastic limit strain of the iron nitride-formed iron alloy sheet.

13. An iron core that is formed of a laminate of soft magnetic iron alloy sheets,
wherein the soft magnetic iron alloy sheet is the soft magnetic iron alloy sheet according to claim 2.

14. A rotating electric machine comprising an iron core,
wherein the iron core is the iron core according to claim 13.
